(19) United States
(12) Patent Application Publication
(10) Pub. No.: US 2013/0214538 A1
(43) Pub. Date: Aug. 22, 2013

(54) Air Cooled Power Feeders for Wind Turbine Applications

(71) Applicant: Richard A. Himmelmann, Beloit, WI (US)

(72) Inventor: Richard A. Himmelmann, Beloit, WI (US)

(73) Assignee: Clipper Windpower, LLC, Carpinteria, CA (US)

(21) Appl. No.: 13/398,026

(22) Filed: Feb. 16, 2012

(51) Int. Cl. F03D 9/00; H02G 5/10

(52) U.S. Cl. 290/55; 174/16.2

(57) ABSTRACT

A wind turbine is disclosed. The wind turbine may comprise a tower having a top and a base, a generator located near the top of the tower, a main shaft operatively connected to the generator, a hub operatively connected to the main shaft, a plurality of blades extending from the hub, and at least one electrical conductor connected to the generator, the conductor configured to carry electric power from the generator to the base of the tower. The wind turbine may further comprise a conduit enclosing the conductor with the conduit having a lower air inlet opening and an upper air outlet opening. The conduit removes heat generated by the conductor by inducing a chimney effect, causing the heat of the conductor to rise up the conduit and out of the tower through the upper air outlet opening, while drawing in air from outside the tower through the lower air inlet opening.

### TECHNICAL FIELD

The present disclosure relates generally to wind turbines and, more particularly, to mechanisms for cooling components of a wind turbine.

### BACKGROUND

In recent years, wind turbines have been integrated into electric power generation systems to create electricity to support the needs of both industrial and residential applications. Such wind turbines capture the kinetic energy of the wind and convert it into electricity. A typical wind turbine includes a set of two or three large blades mounted to a hub. Together, the blades and hub are referred to as the rotor. The rotor is connected to a main shaft, which in turn, is connected to a generator. When the wind causes the rotor to rotate, the kinetic energy of the wind is captured and converted into rotational energy. The rotational energy of the rotor is translated along the main shaft to the generator, which then converts the rotational energy into electricity. The electricity produced by the wind turbine is then distributed to a power utility grid for industrial and residential use.

All wind turbines utilize electrical conductors, such as power cables, bus bars, etc., to bring the electrical power from the top of the tower to the ground where it is conditioned and sent to the utility power grid. These electrical conductors are sized based on the thermal limitations of the insulating material that electrically isolates the cables from one another and the tower structure. The thermal dissipation of the conductor is proportional to the electrical current being carried by the conductor divided by the cross sectional area of the conductor. Therefore, a conductor with a larger cross sectional area has smaller thermal dissipation. As a result, a thicker conductor with a larger cross sectional area would make for a better conductor because it would have less thermal dissipation or heat generated within the wind turbine. However, the cost of these conductors is directly proportional to the amount of conducting material, such as copper in most cases, utilized in their construction. Having thicker conductors thereby increases the cost of the conductors and the overall cost of construction for a wind turbine. Wind turbine designers can use thinner conductors with a smaller amount of conducting material in order to decrease their construction costs. However, thinner conductors with a smaller cross sectional area have greater thermal dissipation and produce more heat within the wind turbine, which in turn, can lead to operational damage of equipment housed within the wind turbine.

Thus, there exists a need for a simplified, inexpensive and reliable means of thermal control for conductors housed within a wind turbine. This disclosure is directed to solving this need and provides a way to reduce the cost and complexity of thermal control for conductors in a wind turbine.

### SUMMARY OF THE INVENTION

According to one embodiment of the present disclosure, a wind turbine is disclosed. The wind turbine may comprise a tower having a top and a base, a generator located near the top of the tower, a main shaft operatively connected to the generator, a hub operatively connected to the main shaft, a plurality of blades extending from the hub, and at least one electrical conductor connected to the generator, the conductor configured to carry electric power from the generator to the base of the tower. The wind turbine may further comprise a conduit enclosing the conductor with the conduit having a lower air inlet opening and an upper air outlet opening.

According to another embodiment, a system for removing heat generated by electrical conductors within a wind turbine is disclosed. The system may comprise a tower of a wind turbine, the tower having a top and a base. The system may further comprise at least one heat generating electrical conductor within the tower, the conductor connected to a generator located near the top of the tower and configured to carry electric power from the generator to the base of the tower. The system may further comprise a conduit configured to remove heat generated by the conductor. The conduit may enclose the conductor and have a lower air inlet opening located near the base of the tower and an upper air outlet opening located near the top of the tower.

According to another embodiment, a wind turbine is disclosed. The wind turbine may comprise a plurality of blades extending from a hub with the hub rotatably mounted to a nacelle, a main shaft operatively connected to the hub, at least one generator operatively connected to the main shaft and contained within the nacelle, and a tower having a top and a base with the top of the tower supporting the nacelle. The tower may contain at least one heat generating electrical conductor connected to the generator with the conductor configured to carry electric power from the generator to the base of the tower, and a conduit enclosing the conductor, the conduit having a lower air inlet opening located near the base of the tower and an upper air outlet opening located near the top of the tower.

According to yet another embodiment, a method for removing heat generated by electrical conductors within a wind turbine is disclosed. The method may comprise providing a wind turbine with a tower having a top and a base, a nacelle mounted to the top of the tower and containing at least one generator, a hub being rotatably mounted to the nacelle and including a plurality of blades radially extending therefrom, a main shaft operatively connected between the hub and the generator, and at least one heat generating electrical conductor connected to the generator and configured to carry electric power from the generator to the base of the tower. The method may further comprise using a conduit to remove heat generated by the electrical conductor, the conduit enclosing the conductor and having a lower air inlet opening located near the base of the tower and an upper air outlet opening located near the top of the tower.

These and other aspects and features of the disclosure will become more readily apparent upon reading the following detailed description when taken in conjunction with the accompanying drawings.

### BRIEF DESCRIPTION OF THE DRAWINGS

FIG. 1 is a perspective view of a wind turbine made according to an embodiment of the present disclosure;

FIG. 2 is a perspective, partial cutaway view of the wind turbine of FIG. 1;

FIG. 3 is a perspective, partial cutaway view of a wind turbine according to another embodiment of the present disclosure;

FIG. 4 is a perspective, partial cutaway view of a wind turbine according to another embodiment of the present disclosure; and

FIG. 5 is a perspective, partial cutaway view of a wind turbine according to yet another embodiment of the present disclosure.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed with the claims appended hereto.

### DETAILED DESCRIPTION

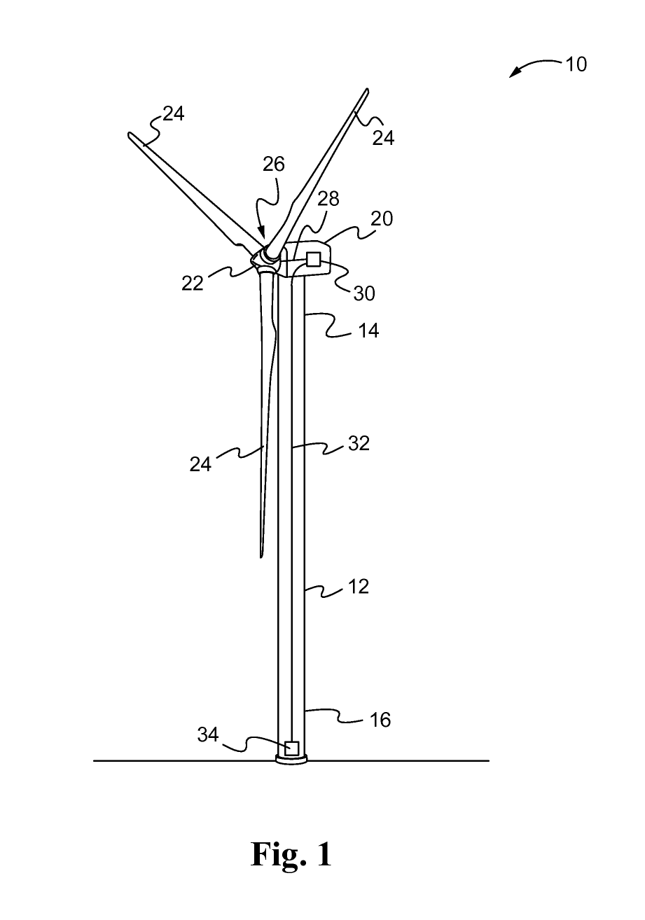

Referring now to the drawings, and with specific reference to FIG. 1, a wind turbine 10 according to one embodiment of the present disclosure is shown. While all components of the wind turbine 10 are not shown or described herein, the wind turbine 10 may include a vertically oriented tower 12. Typically, the tower 12 of a wind turbine 10 may extend upwards to a height of, including but not limited to, two hundred and forty vertical feet (240 ft.) at which the wind turbine 10 can optimally capture the kinetic energy of the wind. Other heights are certainly possible. The tower 12 may have a top 14, and a base 16.

A nacelle 20 may be rotatably mounted at the top 14 of the tower 12 with a hub 22 mounted for rotation to the nacelle 20. Radially extending from the hub 22 are a plurality of blades 24. Together, the hub 22 and blades 24 are referred to as the rotor 26. The rotor 26 may be mounted to a main shaft 28 within the nacelle 20. The main shaft 28 is operatively connected to a generator 30, which may also be contained within the nacelle 20 at the top 14 of the tower 12. One or more electrical conductors 32 may be connected to the generator 30 at the top 14 of the tower 12 and may be configured to carry electric power from the generator 30 to the base 16 of the tower 12. At the base 16 of the tower 12, the conductors 32 may be connected to an electric power conversion system 34. The electric power conversion system 34, mounted at the base 16 of the tower 12, conditions the electric power from the generator 30 for distribution to the utility power grid (not shown). Non-limiting examples of components in an electric power conversion system 34 may include, but not be limited to, any electric power conditioning system, generator control system, passive rectifier, active rectifier, transformer, inverter, and/or liquid cooled inverter.

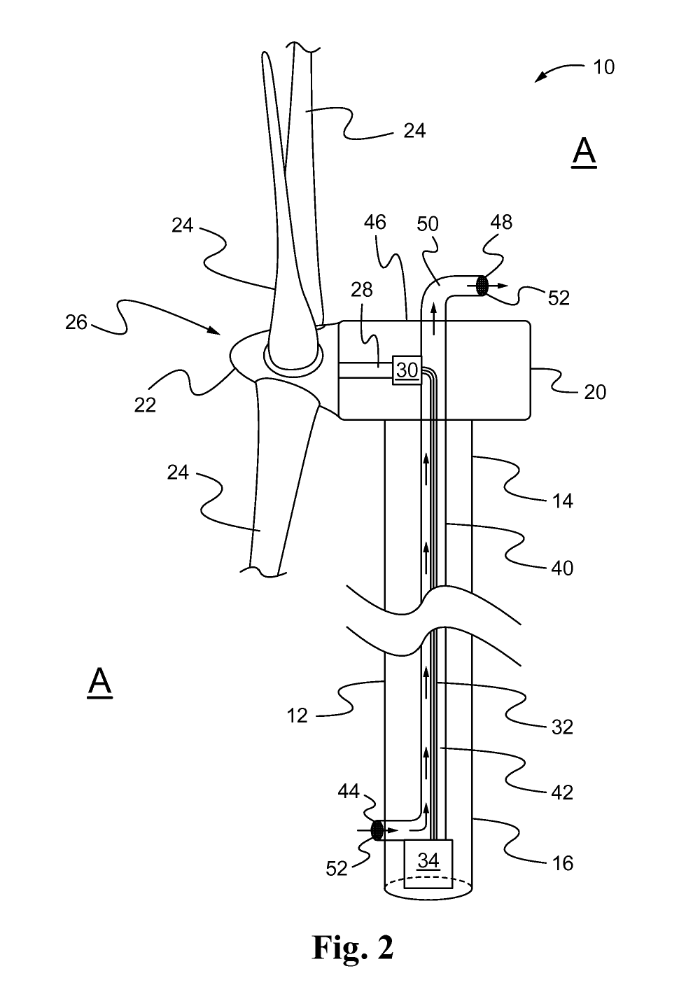

As shown best in FIG. 2, the wind turbine 10 may have a conduit 40 enclosing the electrical conductors 32. The conduit 40 may define a generally enclosed space 42 around the conductors 32 within the tower 12 and the nacelle 20 of the wind turbine 10. Near the base 16 of the tower 12, the conduit 40 may have a lower air inlet opening 44 to the atmosphere A. Near the top 14 of the tower 12 on a top side 46 of the nacelle 20, the conduit 40 may have an upper air outlet opening 48 to the atmosphere A. The conduit 40, mounted in a vertical orientation within the wind turbine 10, extends up from the lower air inlet opening 44 near the base 16 of the tower 12 to the upper air outlet opening 48 near the top 14 of the tower 12 and top side 46 of the nacelle 20, while encompassing the entire length of the conductors 32 from generator 30 to the electric power conversion system 34. Extending from the top side 46 of the nacelle 20, the conduit 40 may have a 90° elbow 50 to allow for the upper air outlet opening 48 to the atmosphere A, while protecting the conductors 32 within the conduit 40 from weather elements, such as rain, sleet, or snow. The lower air inlet opening 44 and upper air outlet opening 48 may include filters 52 to keep dirt and other unwanted particles from entering the wind turbine 10.

As the electrical conductors 32 generate heat due to the thermal dissipation of the current throughout the area of the conducting material, the heat from the conductors 32 is dissipated into the air and space 42 around the conductors 32 within the conduit 40. As the air within the space 42 of the conduit 40 is heated, the density of the air decreases, which in turn, causes the air to rise up the conduit 40. The heated air within the conduit 40 rises up the entire height of the conduit 40 to the top 14 of the tower 12 and top side 46 of the nacelle 20 to the 90° elbow 50, where it is released to the atmosphere A outside of the wind turbine 10 through the upper air outlet opening 48. At the same time, the conduit 40 draws in cooler air from the atmosphere A outside the tower 12 through the lower air inlet opening 44 near the base 16 of the tower 12. As a result of the continual flow of air into the lower air inlet opening 44 over the conductors 32 and out of the upper air outlet opening 48, the conductors 32 are cooled within the conduit 40. By utilizing the ideal gas properties of air, such as the change in density, the conduit 40 induces a chimney effect from the lower air inlet opening 44 to the upper air outlet opening 48. This chimney effect provides a motive force to drive the air along the conductors 32 and remove heat generated by the conductors 32. In this way, the conduit 40 serves as a passive air cooled power feeder for decreasing the operating temperature of the conductors 32.

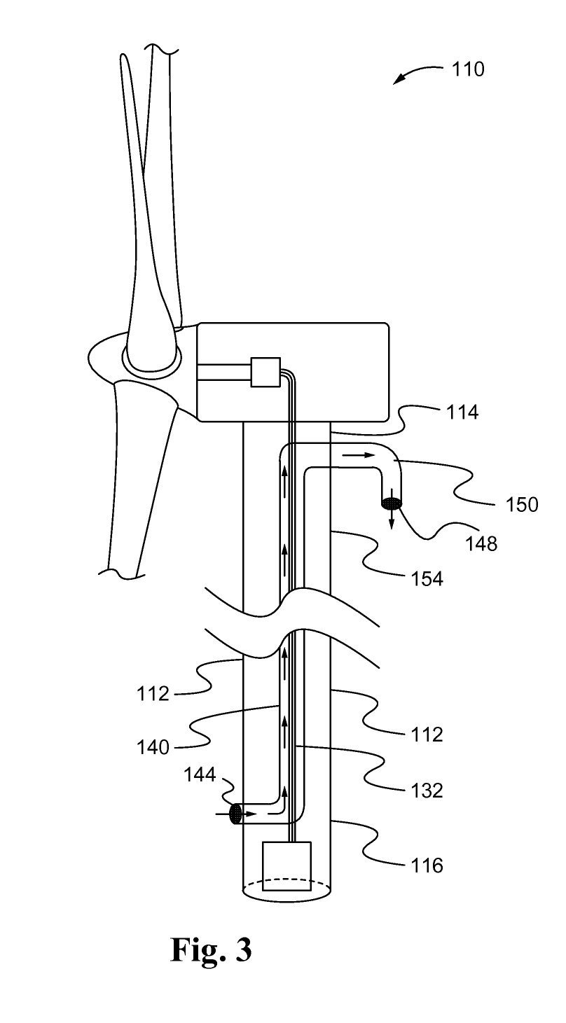

Although shown and described in FIG. 2 as fully enclosing the entire length of the conductors 32 from the electric power conversion system 34 to the generator 30, the conduit 40 may not enclose the full length of the conductors 32 while still inducing the chimney effect. According to another embodiment shown in FIG. 3, the conduit 140 of the wind turbine 110 may have a lower air inlet opening 144 near the base 116 of the tower 112 and an upper air outlet opening 148 near the top 114 of the tower 112 and may enclose a part of the length of the conductors 132. The 90° elbow 150 of the conduit 140 may be placed on the side 154 of the tower 112.

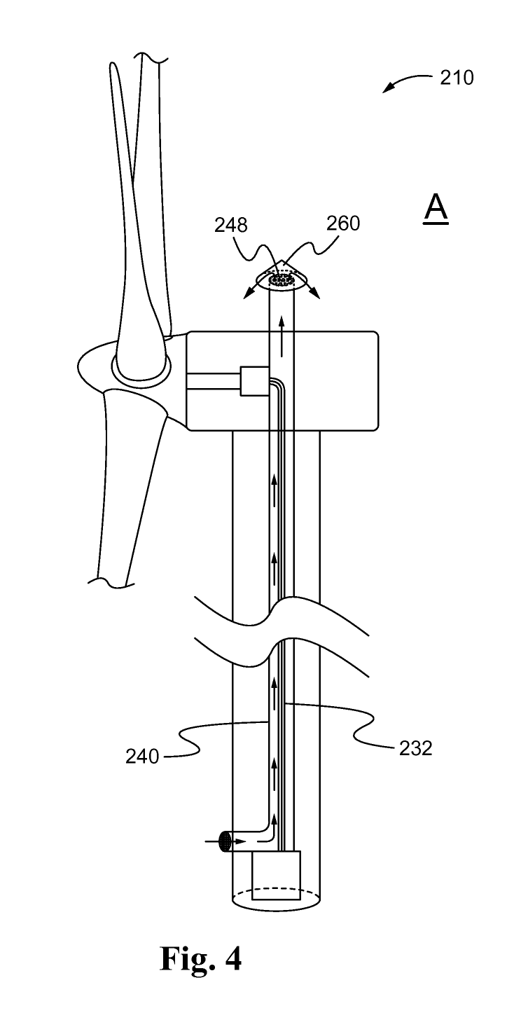

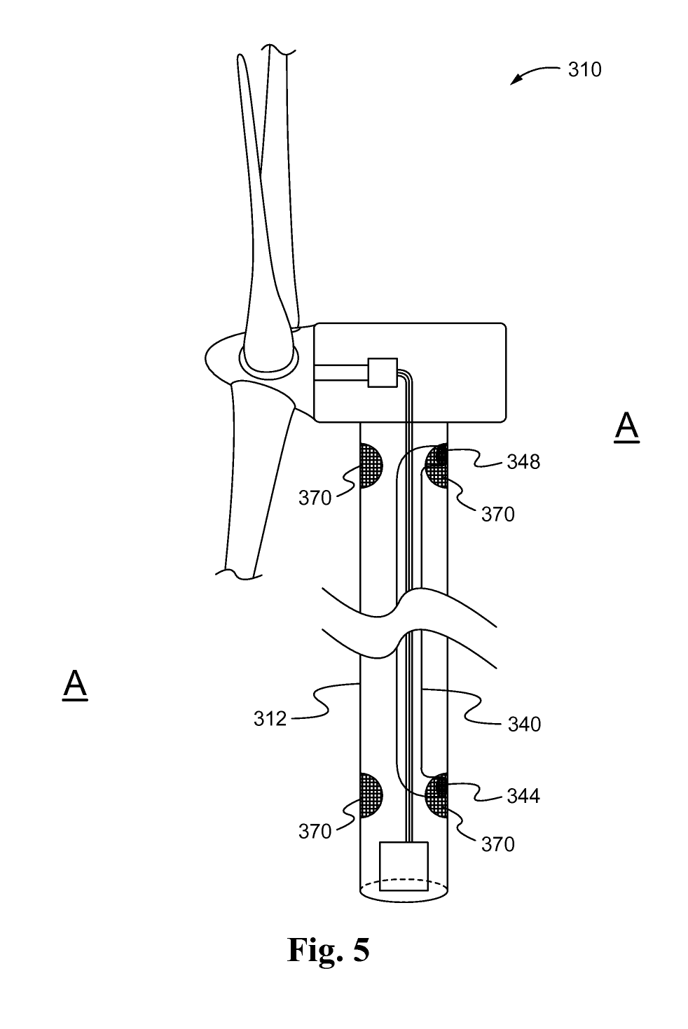

Although shown and described as having a 90° elbow 50, 150 in FIGS. 2 and 3, respectively, the conduit may comprise any structure for the lower air inlet opening and upper air inlet opening that allows for any passage of air from the atmosphere A into the conduit and from the conduit to the atmosphere A. According to another embodiment shown in FIG. 4, the conduit 240 of the wind turbine 210 may have a conical-shaped cap 260 above the upper air outlet opening 248 to allow for the heated air to be released into the atmosphere A while providing protection to the conductors 232 from weather-related elements. According to another embodiment shown in FIG. 5, the wind turbine 310 may have vents 370 cut out on the sides of the tower 312 to allow passage of air from the atmosphere A into the tower 312. In this embodiment, openings 344, 348 of the conduit 340 may be connected to the pre-installed vents 370 in order to allow airflow into and out of the conduit 340. In all instances, it will be understood that due to the conduit and the ideal gas properties of air, a chimney effect is induced from the lower air inlet opening to the upper air outlet opening to remove heat generated by the conductors. Furthermore, although shown and described as removing heat generated by the conductors, the conduit may be used to remove heat generated by the electric power conversion system or any other heat generated within the wind turbine without departing from the scope of this disclosure.

From the foregoing, it can be seen that the present disclosure sets forth an improved means of thermal control which can be used to efficiently remove heat from components within a wind turbine. More specifically, the conduit of the present disclosure provides a way to reduce the size and cost of power conductors within a wind turbine. Furthermore, by being passive in design, the conduit not only cools the components of the wind turbine, particularly the electrical components of the wind turbine, but also does so in an energy efficient manner to thus keep operating costs as well as initial construction costs low.

What is claimed is:

1. A wind turbine, comprising:
a tower having a top and a base;
a generator located near the top of the tower;
a main shaft operatively connected to the generator;
a hub operatively connected to the main shaft;
a plurality of blades extending from the hub;
at least one electrical conductor connected to the generator, the conductor configured to carry electric power from the generator to the base of the tower; and
a conduit enclosing the conductor, the conduit having a lower air inlet opening and an upper air outlet opening.

2. The wind turbine of claim 1, wherein the lower air inlet opening of the conduit is located near the base of the tower.

3. The wind turbine of claim 2, wherein the upper air outlet opening of the conduit is located near the top of the tower.

4. The wind turbine of claim 3, wherein the conduit draws in air from outside the tower through the lower air inlet opening.

5. The wind turbine of claim 4, wherein the conduit releases air to the outside of the tower through the upper air outlet opening.

6. The wind turbine of claim 5, wherein the conductor generates heat within the conduit.

7. The wind turbine of claim 6, wherein the conduit is configured to remove the heat generated by the conductor.

8. The wind turbine of claim 7, wherein the conduit induces a chimney effect causing the heat of the conductor to rise up the conduit and out of the tower through the upper air outlet opening.

9. A system for removing heat generated by electrical conductors within a wind turbine, comprising:
a tower of a wind turbine, the tower having a top and a base;
at least one heat generating electrical conductor within the tower, the conductor connected to a generator located near the top of the tower and configured to carry electric power from the generator to the base of the tower; and
a conduit configured to remove heat generated by the conductor, the conduit enclosing the conductor, the conduit having a lower air inlet opening located near the base of the tower and an upper air outlet opening located near the top of the tower.

10. The system claim 9, wherein the conduit draws in air from outside the tower through the lower air inlet opening.

11. The system claim 10, wherein the conduit releases air to the outside of the tower through the upper air outlet opening.

12. The system of claim 11, wherein the conduit induces a chimney effect causing the heat generated by the conductor to rise up the conduit and out of the tower through the upper air outlet opening.

13. A wind turbine, comprising:
a plurality of blades extending from a hub, the hub rotatably mounted to a nacelle;
a main shaft operatively connected to the hub;
at least one generator operatively connected to the main shaft and contained within the nacelle; and
a tower having a top and a base, the top of the tower supporting the nacelle, the tower containing:
at least one heat generating electrical conductor connected to the generator, the conductor configured to carry electric power from the generator to the base of the tower; and
a conduit enclosing the conductor, the conduit having a lower air inlet opening located near the base of the tower and an upper air outlet opening located near the top of the tower.

14. The wind turbine of claim 13, wherein the conduit draws in air from outside the tower through the lower air inlet opening.

15. The wind turbine of claim 14, wherein the conduit releases air to the outside of the tower through the upper air outlet opening.

16. The wind turbine of claim 15, wherein the conduit induces a chimney effect causing the heat generated by the conductor to rise up the conduit and out of the tower through the upper air outlet opening.

17. A method for removing heat generated by electrical conductors within a wind turbine comprising:
providing a wind turbine with a tower having a top and a base, a nacelle mounted to the top of the tower and containing at least one generator, a hub being rotatably mounted to the nacelle and including a plurality of blades radially extending therefrom, a main shaft operatively connected between the hub and the generator, and at least one heat generating electrical conductor connected to the generator and configured to carry electric power from the generator to the base of the tower; and
using a conduit to remove heat generated by the electrical conductor, the conduit enclosing the conductor and having a lower air inlet opening located near the base of the tower and an upper air outlet opening located near the top of the tower.

18. The method of claim 17, further comprising drawing in air from outside the tower into the conduit through the lower air inlet opening of the conduit.

19. The method of claim 18, further comprising releasing air from the conduit to the outside of the tower through the upper air outlet opening of the conduit.

20. The method of claim 19, wherein the conduit induces a chimney effect causing the heat generated by the conductor to rise up the conduit and out of the tower through the upper air outlet opening.
